(19) United States
(12) Patent Application Publication
(10) Pub. No.: US 2026/0195635 A1
(43) Pub. Date: Jul. 9, 2026

(54) MODELING NEGATIVE USER EXPERIENCE WITH CONNECTIONS NETWORK NOTIFICATIONS

(71) Applicant: Microsoft Technology Licensing, LLC, Redmond, WA (US)

(72) Inventors: Padmini JAIKUMAR, Los Altos, CA (US); Haohua WAN, Sunnyvale, CA (US); Jean Young KIM, Atlanta, GA (US); Tianqi WANG, Mountain View, CA (US); Tianqi LI, San Jose, CA (US); Prakruthi PRABHAKAR, Santa Clara, CA (US); Viral GUPTA, Lathrop, CA (US)

(21) Appl. No.: 19/008,846

(22) Filed: Jan. 3, 2025

(51) Int. Cl. G06N 20/00

(52) U.S. Cl. CPC G06N 20/00

(57) ABSTRACT

Aspects of the disclosure include methods and systems for modeling negative user experiences with notifications. A method includes collecting notification engagement patterns for a plurality of recipients. The notification engagement patterns each include one or more recipient actions in a sequence ending with a disinterest action. Each notification engagement pattern is assigned to a disinterest class of a plurality of predetermined disinterest classes according to the disinterest action for the respective notification engagement pattern and dynamically labeled training data is generated from the notification engagement patterns. Positive labels are assigned to actions within a respective notification engagement pattern according to the disinterest class of the notification engagement pattern. A model is trained using the dynamically labeled training data to generate disinterest predictions for candidate notifications to be delivered to recipients.

### INTRODUCTION

The subject disclosure relates to connections networks, online platforms, and content recommendation, and specifically to the modeling of negative user experiences with connection network notifications.

### A BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the present disclosure are apparent from the following detailed description taken in conjunction with the accompanying drawings in which:

FIG. 1 depicts a block diagram for predicting notification disinterest in accordance with one or more embodiments;

FIG. 2 depicts a block diagram for predicting multi-task notification actions in accordance with one or more embodiments;

FIG. 3 depicts a block diagram for labeling data and training a model to predict notification disinterest in accordance with one or more embodiments;

FIG. 4 depicts a block diagram of the labeled data generator of FIG. 3 in accordance with one or more embodiments;

FIG. 5A depicts a block diagram of a disinterest action in accordance with one or more embodiments;

FIG. 5B depicts a block diagram of a disinterest action in accordance with one or more embodiments;

FIG. 6 depicts a block diagram of a training data labeling phase in accordance with one or more embodiments;

FIG. 7A depicts a block diagram of an example training data labeling phase for an application uninstallation in accordance with one or more embodiments;

FIG. 7B depicts a block diagram of an example training data labeling phase for an in-application deletion attribution in accordance with one or more embodiments;

FIG. 8A depicts a block diagram of an example training data labeling phase for a push notification disable in accordance with one or more embodiments;

FIG. 8B depicts a block diagram of an example training data labeling phase for a push notification dismiss in accordance with one or more embodiments;

FIG. 9 depicts a block diagram of an example training data labeling phase for an in-application notification type disable in accordance with one or more embodiments;

FIG. 10 depicts a block diagram of a neural network in accordance with one or more embodiments;

FIG. 11 depicts a block diagram of a transformer-type model implementation in accordance with one or more embodiments;

FIG. 12 depicts a block diagram of a computer system according to one or more embodiments; and

FIG. 13 depicts a flowchart of a method in accordance with one or more embodiments.

The diagrams depicted herein are illustrative. There can be many variations to the diagram or the operations described therein without departing from the spirit of this disclosure. For instance, the actions can be performed in a differing order or actions can be added, deleted or modified.

In the accompanying figures and following detailed description of the described embodiments of this disclosure, the various elements illustrated in the figures are provided with two or three-digit reference numbers. With minor exceptions, the leftmost digit(s) of each reference number corresponds to the figure in which its element is first illustrated.

### DETAILED DESCRIPTION

### Overview

Notifications serve as a medium for delivering timely and relevant information to users on a variety of networks, including connection networks and social media platforms. Users interact with these notifications through various actions such as clicking, tapping, or dismissing them. When users find notifications useful, they engage with them, enhancing their overall experience on the platform. When users find notifications irrelevant or intrusive, they may exhibit implicit disinterest through actions like ignoring the notification, or explicit disinterest by dismissing the notification, or disabling that type of notification. In some cases, users may disable notifications entirely or may even uninstall the underlying application, leading to a permanent loss of communication with the user.

Current notification systems primarily focus on predicting positive engagement actions. For example, a social network might use algorithms to determine which notifications are most likely to result in a user clicking on a link, liking a post, or commenting on a status update. These systems analyze user behavior and preferences to deliver notifications that are expected to generate positive interactions, thereby enhancing user engagement and activity on the platform. Unfortunately, these systems often lack mechanisms to predict and mitigate negative user actions, which can significantly impact user retention and satisfaction.

Tracking and predicting negative engagement actions towards a notification can be more difficult than doing so for positive engagement actions due to a few technical challenges unique to the negative engagement context. In particular, negative actions, such as disabling notifications or uninstalling an application after receiving a notification, occur less frequently compared to positive engagement actions such as clicks or likes. In other words, negative engagement actions suffer from a sparsity of data problem, and it is relatively more challenging to gather sufficient examples to train accurate predictive models for negative behavior. The infrequent nature of these negative actions means that there are fewer data points available to understand and predict such behaviors, complicating the development of robust models that can effectively anticipate and mitigate user disinterest. Moreover, the variety of negative actions itself presents a technical challenge, as users can express disinterest in notifications by ignoring them, dismissing them, disabling specific types of notifications, disabling all notifications, blocking a sender of a notification, or uninstalling the underlying application altogether. Each of these actions has different implications and severities, as well as sequential and/or contextual dependencies.

Another technical challenge related to the understanding and prediction of negative engagement actions is a so-called attribution complexity, as determining the specific notification or sequence of notifications that led to a negative action is relatively more complex than the positive engagement case. For example, when a user clicks on or engages with a notification it is relatively straightforward to judge the reaction to the notification delivery as a positive engagement. On the other hand, users may take a negative action towards a notification due to a dislike of that particular notification, due to a cumulative effect of multiple notifications over time, or due to a combination of both, making it difficult to attribute the cause to a single event or interaction.

The absence of models to predict negative engagement actions, also referred to as disinterest actions, limits the ability to make informed decisions when selecting and sending notifications, potentially leading to user frustration and disengagement. Addressing this gap requires developing new model architectures that can capture and predict a user's propensity for disinterest, enabling a more balanced and user-centric approach to notification delivery.

This disclosure introduces a notification disinterest prediction system for modeling negative user experiences towards candidate notifications, for example, within a connections network. The notification disinterest prediction system described herein leverages advanced machine learning techniques to predict a user's likelihood of disinterest based on their past interactions with notifications as well as information specific to the notification itself, the intended recipient of the notification, and the actor of the notification (the entity or person about whom the notification is associated).

One of the key features of the present system includes the generation of dynamically labeled training data using, in part, a dynamic lookback and labeling procedure. In this implementation, a variety of different types, or classes, of notification engagement patterns are designated, each having one or more actions in a sequence that ends with a disinterest action. The disinterest action can be unique to the class of the respective notification engagement pattern, meaning that each pattern can be uniquely defined among the different classes of patterns according to the final disinterest action. Candidate training data can then be assigned to the various classes, and then labeled using different labeling policies according to those classes. One of the labeling policies includes a dynamic lookback, which defines, for each specific class, how far back in the candidate training data to consider when labeling training data. Data outside of the dynamic lookback is discarded, even if otherwise valid. Other labeling policies are possible and can be, advantageously, unique to each class.

To illustrate, consider a scenario where a user receives multiple notifications over a period of time. If the user ignores the first few notifications but eventually disables the notification type, the system may label the initial ignored notifications as positive indicators of disinterest for that specific class. Conversely, if the user clicks on a notification but later disables the notification type, the click action might be labeled as a negative indicator for another class. By assigning different labeling policies to the candidate data, the system can capture the nuanced ways in which users exhibit disinterest. This approach allows the same piece of candidate training data to have different labels (positive, negative, ignored, etc.) depending on the policy, thereby enriching the otherwise sparce training dataset and improving the notification disinterest prediction system's ability to predict disinterest accurately.

By capturing a holistic view of a user's engagement patterns, the system can identify and mitigate potential negative actions before they occur. This proactive approach helps maintain a positive user experience by reducing the likelihood of notification disablement, application uninstallation, push dismissals, etc. Additionally, the system's ability to personalize predictions for individual users ensures that notifications are more relevant and less intrusive, leading to higher user satisfaction and retention. Overall, the notification disinterest prediction system described herein offers a sophisticated solution for balancing notification quality and delivery, enhancing user engagement, and minimizing negative user experiences on social networks and connections platforms.

### DETAILED EMBODIMENT

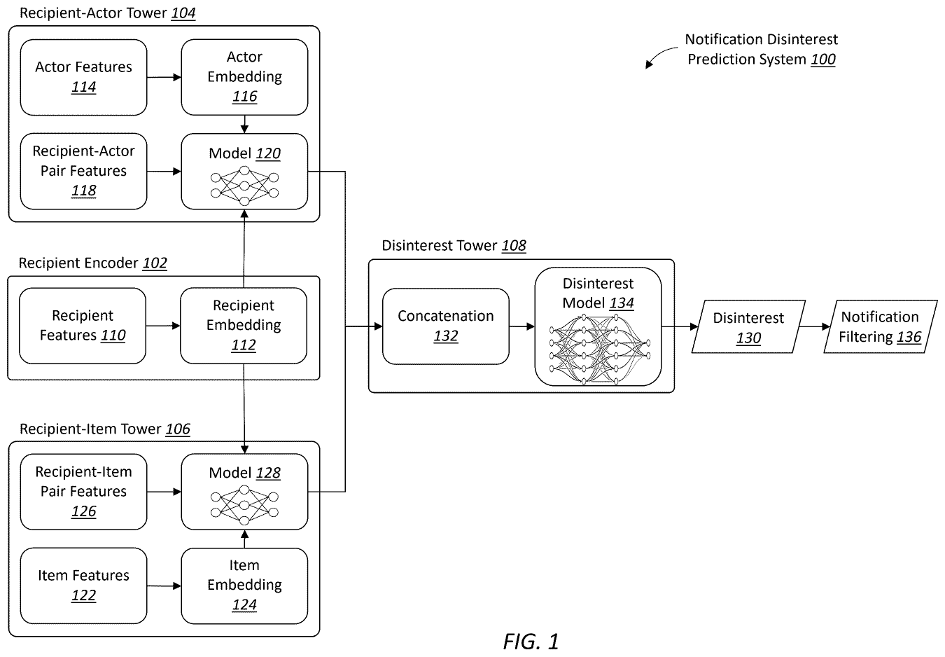

FIG. 1 depicts a block diagram for a notification disinterest prediction system 100 in accordance with one or more embodiments. As will be described in further detail herein, the notification disinterest prediction system 100 includes a recipient encoder 102, a recipient-actor tower 104, a recipient-item tower 106, and a disinterest tower 108, configured and arranged as shown. In some embodiments, a recipient refers to a candidate target or actual target of a candidate notification or a delivered notification, an actor refers to the entity for which the notification offers information for or about, and an item refers to the notification itself. While not meant to be particularly limited, notifications can be delivered within a connections network such as a social network. For example, a notification might be sent to user A suggesting, as a potential connection, user B. In this example, the recipient is user A, the actor is user B, and the item is the connection recommendation notification.

In some embodiments, the recipient encoder 102 receives recipient features 110 and generates, responsive to receiving the recipient features 110, a recipient embedding 112. Recipient features 110 refer to the set of attributes and data points that characterize a recipient of a notification. These features capture various aspects of the recipient's behavior, preferences, and interactions within the underlying network or platform, which are used to generate a personalized representation of the recipient for the purpose of predicting their engagement or disinterest with notifications. Examples of recipient features 110 can include engagement history data including a recipient's past interactions with one or more notifications, such as the number of notifications clicked, ignored, or dismissed, prior disinterest actions they have exhibited in any predetermined time windows (e.g., within prior 1 day, 7 days, 14 days, 28 days, 45 days, 6 months, 1 year, etc.) such as the number of notifications received, but not engaged with, a number of deletes on a notification type, etc., activity level data including the frequency and recency of the recipient's activity such as daily logins, session duration, and the number of posts or comments made, profile information including demographic and profile details of the recipient, such as their location, industry, job title, and education background, content preferences such as the specific topics, hashtags, authors, content length, etc., they frequently engage with or show interest in, notification settings including the recipient's preferences for receiving notifications, such as the types of notifications enabled or disabled, and the preferred channels (e.g., in-app, push, email, etc.), and social connection data including information about the recipient's network, such as the number of connections, interactions with specific connections, and common connections with the actor sending the notification.

Recipient embedding 112 refers to a vector representation of the recipient's features, capturing the essential characteristics and behaviors of the recipient in a format that can be used by machine learning models. This embedding is generated by processing the recipient features 110 through the recipient encoder 102. Encoders transforms raw input data into a dense, low-dimensional representation that preserves the most relevant information for predicting engagement or disinterest with notifications.

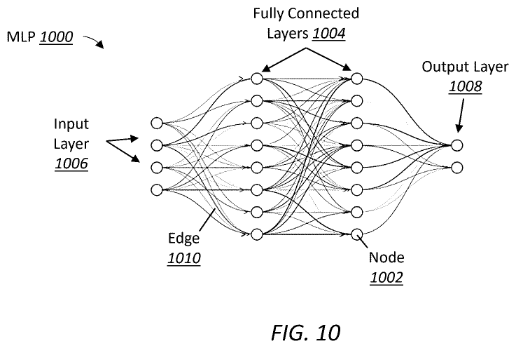

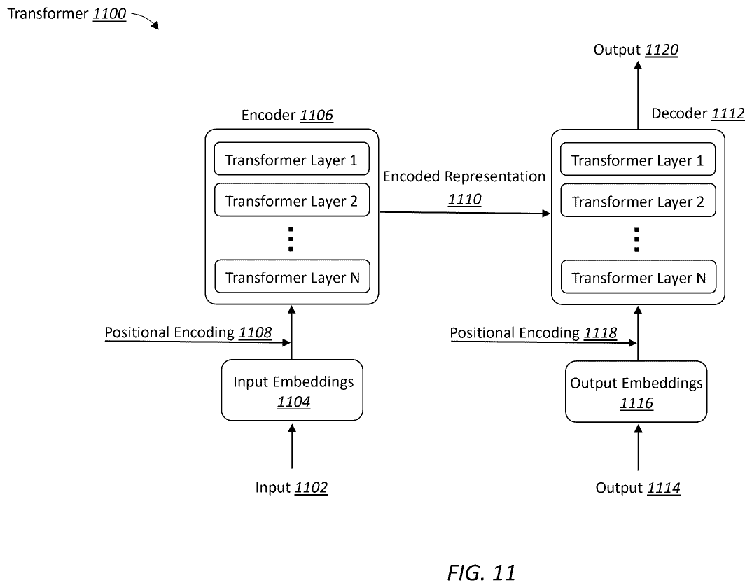

The recipient encoder 102 is not meant to be particularly limited, but can include, for example, a neural network encoder, a transformer encoder, an autoencoder, an embedding layer, and/or a feature aggregator. A neural network model, such as a multilayer perceptron (MLP) or a recurrent neural network (RNN), processes input features (e.g., recipient features 110) through multiple layers to generate an output embedding (e.g., recipient embedding 112). FIG. 10 illustrates an example MLP configuration. A transformer-based model uses self-attention mechanisms to process recipient features. This type of encoder can capture long-range dependencies and contextual information, making it suitable for handling diverse and complex recipient data. FIG. 11 illustrates an example transformer configuration. An autoencoder compresses recipient features 110 into a lower-dimensional representation (the recipient embedding 112) and then reconstructs the original features. The compressed representation captures the most important information about the recipient. A relatively simple embedding layer can map categorical recipient features (e.g., user ID, demographic categories, etc.) to dense vector representations. This layer can be used in combination with other types of encoders to generate a comprehensive recipient embedding 112. A feature aggregator can aggregate various recipient features, such as engagement history, activity metrics, and profile information, into a single vector representation. This aggregation can be done using techniques like averaging, concatenation, or weighted summation, as desired. Encoders are discussed in greater detail with respect to FIG. 11.

In some embodiments, the recipient-actor tower 104 receives actor features 114 and generates, responsive to receiving the actor features 114, an actor embedding 116. The actor embedding 116 can be generated using an encoder in a similar manner as discussed with respect to the recipient embedding 112. The actor features 114 refer to the set of attributes and data points that characterize a sender or source of a notification, in a similar manner as the recipient features 110 refers to the characteristics of the recipient. These features capture various aspects of the actor's behavior, preferences, and interactions within the underlying network or platform, which are used to generate a personalized representation of the actor. Examples of actor features 114 can include engagement history data including an actor's past interactions with one or more notifications, such as the number of notifications clicked, ignored, or dismissed, activity level data including the frequency and recency of the actor's activity such as daily logins, session duration, and the number of posts or comments made, profile information including demographic and profile details of the actor, such as their age, location, industry, job title, and education background, content preferences such as the specific topics, hashtags, authors, content length, etc., they frequently engage with or show interest in, notification settings including the actor's preferences for receiving notifications, such as the types of notifications enabled or disabled, and the preferred channels (e.g., in-app, push, email, etc.), and social connection data including information about the actor's network, such as the number of connections, interactions with specific connections such as the recipient, and common connections with the recipient receiving the notification.

In some embodiments, the recipient-actor tower 104 receives, in addition to the actor features 114, recipient-actor pair features 118. Recipient-actor pair features 118 refer to the set of attributes and data points that characterize the relationship and interactions between the recipient and the actor (sender or source) of a notification. These features capture various aspects of the dynamic between the recipient and the actor, which can influence the recipient's engagement or disinterest with the notifications sent by that actor. Examples of recipient-actor pair features 118 include, for example, a full or partial (to any desired depth) history of interactions between the recipient and the actor, such as the number of messages exchanged, comments made on each other's posts, and likes or reactions to each other's content, connection similarity data such as the number of mutual connections or friends shared between the recipient and the actor, engagement patterns specific to the recipient-actor pair, such as the frequency and recency of the recipient's responses to notifications or content from the actor, content affinity data such as the recipient's learned affinity for the type of content typically shared by the actor, including topics, hashtags, and formats (e.g., text, images, videos) of shared content, the presence and frequency of reciprocal actions including the extent to which the recipient and actor like each other's posts, comment on each other's updates, or sharing each other's content, notification response data including the recipient's historical response to notifications specifically sent by the actor, including metrics like click-through rates, dismissals, and disablements, and social context data including the extent to which the recipient and actor are part of the same groups, attend the same events, work in the same industry, etc.

In some embodiments, the actor embedding 116 and the recipient-actor pair features 118 are fed as input to an internal model 120 (also referred to as a recipient-actor tower model). The model 120 is not meant to be particularly limited, but can include, for example, a neural network, MLP, RNN, a transformer, an autoencoder, an embedding layer(s), and/or a feature aggregator. In some embodiments, model 120 generates, responsive to receiving the actor embedding 116 and the recipient-actor pair features 118, an output embedding (not separately indicated) that is fed as input to the disinterest tower 108. In this manner, the disinterest tower 108 can leverage the actor and recipient-actor features when evaluating a candidate notification.

In some embodiments, the recipient-item tower 106 receives item features 122 and generates, responsive to receiving the item features 122, an item embedding 124. The item embedding 124 can be generated using an encoder in a similar manner as discussed with respect to the recipient embedding 112. The item features 122 refer to the set of attributes and data points that characterize the notification itself, in a similar manner as the recipient features 110 refers to the characteristics of the recipient. Examples of item features 124 can include, for example, content type data such as whether the notification includes text, image, video, and/or link data, content length such as the number of characters in a text notification or the duration of a video, topic and hashtag data indicating the subject matter of the notification, engagement metrics such as historical engagement metrics for the same or similar notifications, such as average click-through rates, likes, shares, and comments, timestamp data such as the time and date when the notification was generated and/or sent, priority data such as how prominently the notification is displayed to the recipient, channel data defining the delivery means for the notification, such as in-app delivery, a push notification, an email, and/or messaging such as SMS, and visual data including an amount and presence of visual elements such as images, icons, or thumbnails that accompany the notification content.

In some embodiments, the recipient-item tower 106 receives, in addition to the item features 122, recipient-item pair features 126. Recipient-item pair features 126 refer to the set of attributes and data points that characterize the relationship and interactions between the recipient and the notification characteristics. Examples of recipient-item pair features 126 include, for example, a full or partial (to any desired depth) history of interactions between the recipient and the notification or similar notifications, such as the number of times the recipient clicked, ignored, dismissed, liked, etc. the notification or a similar notification. As used herein, a similar notification means a notification having one or more shared characteristics with the notification, such as a same content type, hashtag, content length, etc. Similarity can be quantified explicitly by comparing the item embeddings 124 according to any desired distance measure (e.g., Euclidian distance, cosine similarity, etc.). Other examples of recipient-item pair features 126 include engagement patterns including the frequency and recency of the recipient's responses to similar notifications, content affinity including the recipient's affinity for the type of content in the notification, including topics, hashtags, and formats (e.g., text, images, videos), response data including the recipient's historical response to notifications with similar characteristics, including metrics like click-through rates, dismissals, and disablements, timing data such as the observed number of interactions with content in general, and/or similar content according to the time of day, day of week, etc., contextual data such as the type of activities which have previously co-occurred with desirable notification engagements, visual preference data including the recipient's preferences for visual elements in the candidate notification, such as the presence of images, icons, or thumbnails, and channel preference data include the recipient's preferences for the intended candidate notification channel, such as in-app, push, email, or SMS delivery.

In some embodiments, the item embedding 124 and the recipient-item pair features 126 are fed as input to an internal model 128 (also referred to as a recipient-item tower model). The model 128 is not meant to be particularly limited, but can include, for example, a neural network, MLP, RNN, a transformer, an autoencoder, an embedding layer(s), and/or a feature aggregator. In some embodiments, model 128 generates, responsive to receiving the item embedding 124 and the recipient-item pair features 126, an output embedding (not separately indicated) that is fed as input to the disinterest tower 108. In this manner, the disinterest tower 108 can leverage the item and recipient-item features when evaluating a candidate notification.

In some embodiments, the disinterest tower 108 receives the respective outputs (embeddings) from the recipient-actor tower 104 and the recipient-item tower 106 and generates, in response, a disinterest prediction (or simply, disinterest 130). In some embodiments, disinterest tower 108 generates a concatenation 132 from the respective outputs (embeddings) from the recipient-actor tower 104 and the recipient-item tower 106 and feeds this concatenation 132 to a disinterest model 134. For example, the outputs from the recipient-actor tower 104 and the recipient-item tower 106 can be vector embeddings and those embeddings can be concatenated to generate the concatenation 132.

The disinterest model 134 can be implemented using various machine learning architectures, such as neural networks (e.g., MLPs, RNNs, deep learning networks), transformer models, or other advanced ML architectures. The choice of architecture depends on the complexity and nature of the input features and the desired prediction accuracy.

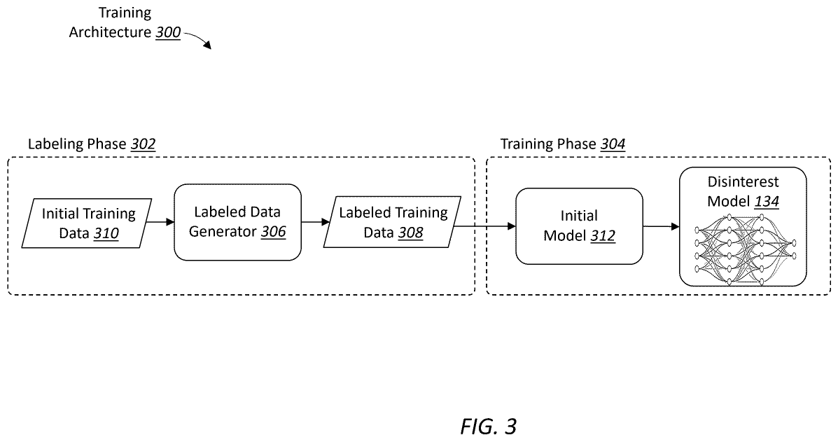

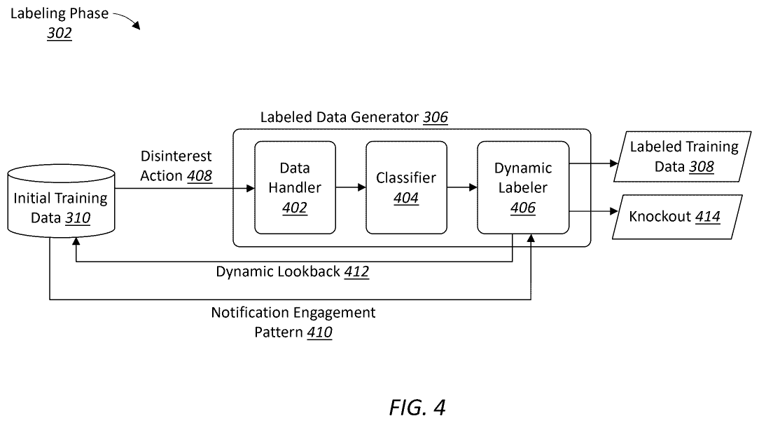

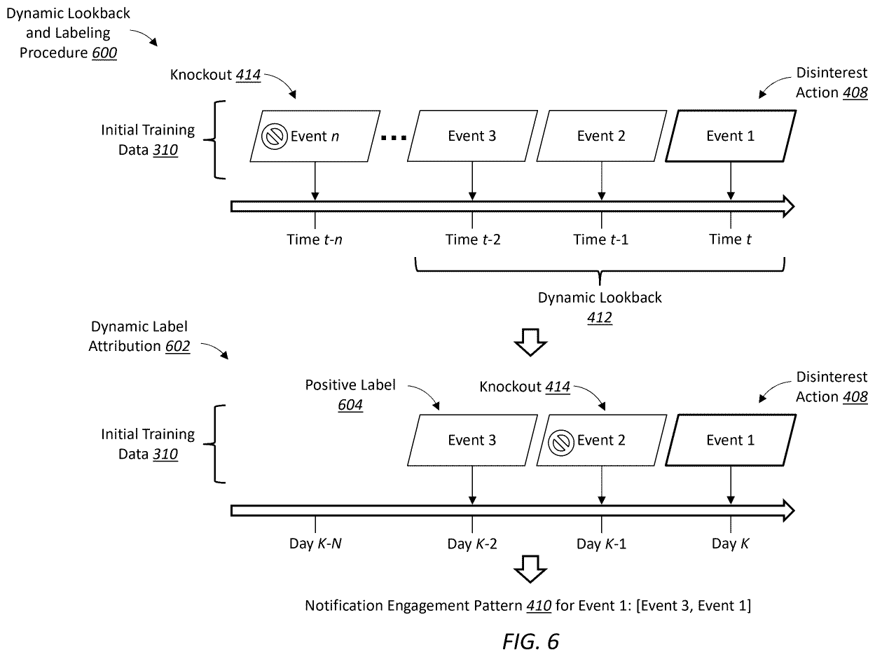

In some embodiments, disinterest model 134 is trained on dynamically labeled training data using, in part, a dynamic lookback and labeling procedure (refer to FIG. 6). This procedure assigns labels to training data based on the sequence of actions leading to a disinterest action, allowing the model to learn from both positive and negative engagement patterns. In some embodiments, the disinterest model 134 is trained to minimize a loss function that quantifies the difference between a predicted notification disinterest scores and an actual notification disinterest actions observed in the training data. Common loss functions include cross-entropy loss for classification tasks and mean squared error (MSE) for regression tasks. Training the disinterest model 134 is discussed in greater detail with respect to FIGS. 3 and 4.

During an inference phase, the disinterest model 134 can receive a candidate notification and can generate, in response, disinterest 130. In some embodiments, disinterest 130 serves as a disinterest prediction score for filtering candidate notifications via notification filtering 136. For example, candidate notifications having a score below (or above) a predetermined threshold can be removed (filtered) prior to delivery to a recipient. In this manner, the notification disinterest prediction system 100 can be used to filter, in real-time, the delivery of notifications to arbitrarily sized recipient pools, improving user experiences across the underlying network. Notably, the disinterest model 134 can learn, during training, to output disinterest predictions that are personalized to the individual recipient of the candidate notification, further ensuring that notifications are relevant and less likely to cause disinterest.

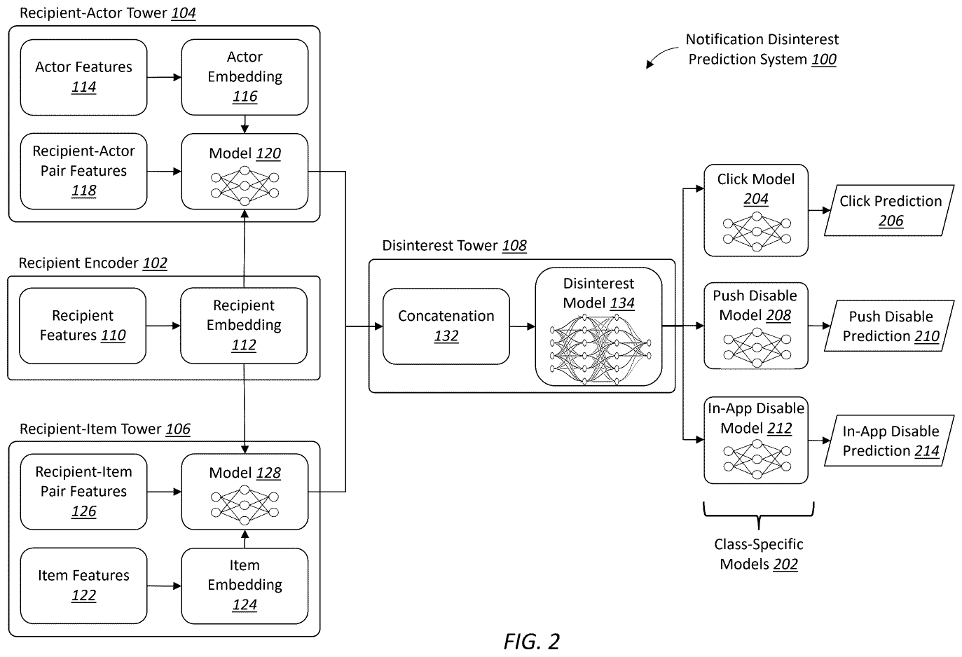

FIG. 2 depicts a block diagram of an extension of the notification disinterest prediction system 100 of FIG. 1 configured for predicting multi-task notification actions in accordance with one or more embodiments. The notification disinterest prediction system 100 shown in FIG. 2 includes the addition of class-specific models 202.

While not meant to be particularly limited, in some embodiments, class-specific models 202 include individual models for each of a plurality of notification actions, such as, for example, a click model 204 trained to predict a probability that a candidate notification will be clicked by a recipient, a push disable model 208 trained to predict a probability that a candidate notification will be disabled by the recipient, and an in-application disable model 212 trained to predict a probability that a candidate notification will result in the recipient disabling notifications within the underlying application from which the notification was received (via, for example, a push). These class-specific models 202 are merely illustrative and others, such as class-specific models trained to predict probabilities that recipients will uninstall the underlying application, probabilities that recipients will disable all notifications of a same type as the candidate notification, probabilities that recipients will dismiss the notification, etc., are possible and within the contemplated scope of this disclosure. In short, class-specific models 202 can be generated for each of a variety of notification actions.

In some embodiments, the output (e.g., disinterest 130 of FIG. 1) of disinterest model 134 can be passed, as input, to the class-specific models 202. The class-specific models 202 can be implemented using various machine learning architectures, such as neural networks (e.g., MLPs, RNNs, deep learning networks), transformer models, or other advanced ML architectures, as desired. In some embodiments, each of the class-specific models 202 is trained separately using labeled training data generated specifically according to the respective type of notification action. For example, click model 204 can be trained on labeled training data of prior notifications having known click data (that is, whether each notification in the training set was clicked after delivery). Similarly, push disable model 208 can be trained on labeled training data of prior notifications having known push disable data (that is, whether each notification in the training set led to a push notifications disable action after delivery).

FIG. 3 depicts a block diagram of a training architecture 300 for labeling data and training a model to predict notification disinterest in accordance with one or more embodiments. As shown in FIG. 3, training architecture 300 includes a labeling phase 302 and a training phase 304.

During labeling phase 302, a labeled data generator 306 leverages a dynamic lookback and labeling procedure (refer to FIG. 6) to generate labeled training data 308 from initial training data 310. The initial training data 310 refers to the dataset used as the starting point for training the recipient encoder 102, recipient-actor tower 104, recipient-item tower 106, and disinterest model 134 (refer to FIG. 1). In some embodiments, initial training data 310 includes notification disinterest data for prior notifications having known engagement data, such as the respective recipient features 110, actor features 114, item features 122, recipient-actor pair features 118, and recipient-item pair features 126 for any number of prior notifications (e.g., thousands, tens of thousands, millions of notifications, etc.). In addition to recipient, actor, and item features, the initial training data 310 can include initial positive and negative labels of the form [notification, label]. As used herein, a positive label means a notification resulted in at least one of one or more predetermined disinterest actions, such as disabling or deleting a notification, while a negative label means a notification was clicked, selected, and/or otherwise engaged with by the recipient. Observe that, in this labeling convention, positive labels are given to notifications that were negative experiences for the respective recipient, while negative labels are given to notifications that were positive experiences for the recipient.

Advantageously, the dynamic lookback and labeling procedure results in an expansion of the initial training data 310. More specifically, the dynamic lookback and labeling procedure results in the generation of additional positive labels (negative notification experiences under this labeling convention), which is an otherwise sparce dataset. The labeling phase 302, and the dynamic lookback and labeling procedure specifically, are discussed in greater detail with respect to FIG. 4.

During training phase 304, an initial model 312 is trained on the labeled training data 308 to generate the disinterest model 134 (refer to FIG. 1). In some embodiments, the initial model 312 processes the labeled training data 308 through one or more layers, for example, using a machine learning architecture such as a neural network, transformer, or other advanced models, to identify patterns and relationships within the labeled training data 308 that are indicative of user disinterest towards a notification. In some embodiments, parameters of the initial model 312 are initialized (randomly or to predetermined parameters learned from prior training phases for the current or any prior model) and adjusted iteratively to minimize a loss function, which quantifies the difference between the predicted disinterest scores and the actual disinterest actions observed in the labeled training data 308. Common loss functions used in this context include cross-entropy loss and mean squared error (MSE).

Throughout the training process, techniques such as backpropagation and gradient descent can be employed to update the internal parameters of the initial model 312, such as the weights and biases of one or more layers, thereby gradually improving its predictive accuracy. The training phase may also involve techniques like regularization to prevent overfitting, ensuring that resultant disinterest model 134 generalizes well to new, unseen data. Additionally, the training process may include validation steps, where a portion of the labeled training data 308 is set aside to evaluate the performance and fine-tune the hyperparameters of the disinterest model 134.

Once the training phase 304 is complete, the resulting disinterest model 134 is capable of generating disinterest predictions for candidate notifications. These predictions can be used to filter or adjust the delivery of notifications as discussed previously (refer to FIG. 1 and notification filtering 136), enhancing user experiences by reducing the likelihood of sending notifications that may lead to user disinterest or disengagement.

FIG. 4 depicts a block diagram of the labeled data generator 306 of FIG. 3 in accordance with one or more embodiments. As shown in FIG. 4, the labeled data generator 306 includes a data handler 402, a classifier 404, and a dynamic labeler 406, configured and arranged as shown.

In some embodiments, data handler 402 preprocesses and/or samples the initial training data 310 for delivery to the classifier 404. Sampling can be performed randomly or based on specific criteria to ensure that the sampled dataset is representative of the overall data distribution in the initial training data 310. Random sampling involves selecting a subset of data points from the initial training data 310 without any specific order or pattern, ensuring that each data point has an equal chance of being included in the training dataset. This approach helps in creating a diverse and unbiased training set that captures various user behaviors and interactions. Additionally, or alternatively, the data handler 402 might employ nonrandom sampling techniques, such as stratified sampling, where the data is divided into different strata or groups based on certain characteristics, such as user demographics, notification types, or engagement patterns. Samples can then be drawn from each stratum in proportion to their representation in the overall dataset. This method ensures that the sampled data includes a balanced representation of different user segments and notification types, which can improve the ability of the disinterest model 134 to generalize across various notification scenarios. In addition to sampling, the data handler 402 may also perform data augmentation techniques, such as generating synthetic data points or applying transformations to existing data, to further enrich the training dataset. These techniques can help in addressing data sparsity issues, thereby improving the robustness of the disinterest model 134 to variations in user behavior.

In some embodiments, the initial training data 310 includes a plurality of disinterest actions 408. While not meant to be particularly limited, disinterest actions 408 can include, for example, ignoring a notification for longer than a predetermined amount of time (e.g., 10 seconds, 1 minute, 5 minutes, an hour, a day, etc.), dismissing a notification, disabling notifications of the same type as the received notification, disabling all notifications, blocking a sender of a notification, or uninstalling the underlying application altogether.

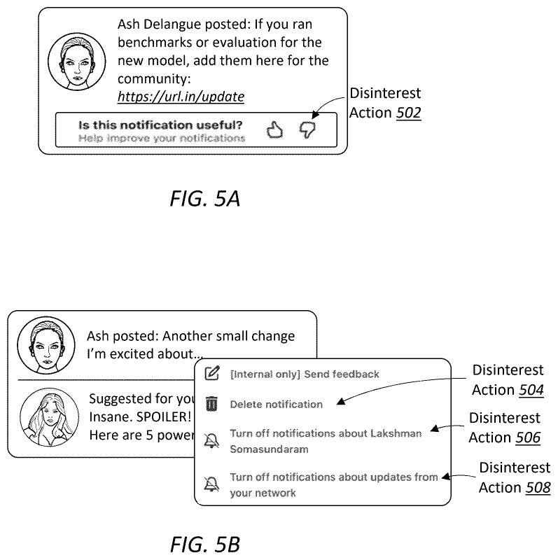

Illustrative examples for various disinterest actions 408 are shown in FIGS. 5A and 5B. More specifically, FIG. 5A depicts a first disinterest action 502, while FIG. 5B depicts a second disinterest action 504, a third disinterest action 506, and a fourth disinterest action 508. The first disinterest action 502 includes the selection, via a tap, a click, or otherwise, of a depicted “thumbs down” icon or widget, the second disinterest action 504 includes selection of a user interface object to “delete notification”, the third disinterest action 506 includes selection of a user interface object to “turn off notifications” regarding a specific actor, and the fourth disinterest action 508 includes selection of a user interface object to “turn off notifications” for all future in-network updates. It should be understood that the first disinterest action 502, second disinterest action 504, third disinterest action 506, and fourth disinterest action 508 are merely illustrative and other disinterest actions 408 are within the contemplated scope of this disclosure.

Returning now to FIG. 4, in some embodiments, classifier 404 assigns each of the disinterest actions 408 in the initial training data 310 (or those sampled via data handler 402) to a class of a plurality of predetermined disinterest classes. While not meant to be particularly limited, the predetermined disinterest classes refer to a set of predefined categories that represent various types of negative user responses to notifications. For example, all of the disinterest actions 408 associated with the disabling of a push notification can be assigned to a “push disable class”, while all of the disinterest actions 408 associated with the deletion of the underlying application can be assigned to an “application uninstall” class. In this manner, classes can then be used to systematically categorize all of the sampled initial training data 310 based on the specific disinterest actions 408 exhibited by users.

In some embodiments, dynamic labeler 406 is configured to receive the classified data from the classifier 404. For example, dynamic labeler 406 can receive a first disinterest action having a first disinterest class and a second disinterest action having a second disinterest class. Of course, this is merely illustrative, and the dynamic labeler 406 can receive thousands or even millions of disinterest actions spanning any number of disinterest classes.

In some embodiments, dynamic labeler 406 is configured to initiate a dynamic lookback and labeling procedure (refer to FIG. 6) according to the respective disinterest class of each disinterest action 408. As discussed previously, each predetermined disinterest class corresponds to a particular type of negative action that a user might take in response to a notification. In some embodiments, the dynamic lookback and labeling procedure is unique for one or more, or even all, of the disinterest classes.

In some embodiments, the dynamic lookback and labeling procedure involves building, for one or more (even all) of the disinterest actions 408, corresponding notification engagement patterns 410 according to the respective dynamic lookback and labeling procedure of the disinterest class of the respective disinterest action 408. Notification engagement patterns 410 refer to the actions and interactions between users and notifications which occur in a sequence that ends with the respective disinterest action 408. These patterns provide valuable insights into how users respond to notifications over time and can help predict future disinterest actions. For example, a first notification engagement pattern 410 that ends with the deletion of a notification might include the delivery of a prior notification to the same user that was also deleted. In another example, a second notification engagement pattern 410 that ends with the disabling of a particular notification type might include the delivery of a string of prior notifications of that same type to the same user which were ignored. Advantageously, the notification engagement patterns 410 can include negative interactions with prior notifications and can thereby serve as additional positively labeled training data, allowing the disinterest model 134 to be trained on a larger, more robust dataset than would otherwise be available (recall, in particular, that positive labels are sparce for disinterest signals in a connections network). In other words, dynamic lookback and labeling enables the capturing of a greater variety of disinterest actions, including rich sequential patterns that can expand the positive label set.

Turning now to FIG. 6, the notification engagement patterns 410 (refer to FIG. 4) can be built according to a dynamic lookback and labeling procedure 600. In some embodiments, dynamic lookback and labeling procedure 600 is a two-step process that includes defining the dynamic lookback 412 and then applying a dynamic label attribution 602 to one or more events (notification actions or interactions) within the dynamic lookback 412.

In some embodiments, dynamic lookback 412 that defines a maximum window of time within which prior actions and interactions with notifications can be attributed to the respective disinterest action 408. For example, dynamic lookback 412 can set a 2-day window, a 4-hour window, a 10-day window, a 14-day window, a 28-day window, etc. Actions and interactions which occur beyond (prior to) this window of time are not considered, and define, in part, a set of data (collectively referred to as knockout 414) that is not included in labeled training data 308. In some embodiments, the dynamic lookback 412 is fixed according to the underlying disinterest class. For example, a push disable disinterest class might have a 10-day dynamic lookback 412, a push dismiss class might have a 14-day dynamic lookback 412, and an application deletion disinterest class might have a 0-duration dynamic lookback 412 (that is, dynamic lookback might not occur for this class at all). In some embodiments, the dynamic lookback 412 is learned for each recipient (user), meaning that the dynamic lookbacks 412 for each underlying disinterest class can themselves vary among the recipients. For example, a push disable disinterest class might have a 10-day dynamic lookback 412 for a first recipient, but a 6-day (or 20-day, etc.) dynamic lookback 412 for a second recipient.

As shown in FIG. 6, the initial training data 310 can include a first event (“Event 1”) representing one of the possible disinterest actions 408. Event 1 might be, for example, the deletion of a notification, or a dismissal of a push notification, a blocking of a notification type of a received notification, etc. Event 1 can be fetched from the initial training data 310 via the data handler 402 (refer to FIG. 4). In some embodiments, Event 1 is preceded by one or more other notification actions and interactions, such as, for example, prior dismissals and deletions of notifications, prior notification type disables, etc.

In some embodiments, dynamic lookback 412 defines the maximum period of time a preceding event must be from Event 1 to remain in consideration for the notification engagement pattern 410 for the respective disinterest action 408. Events which occur prior to the dynamic lookback 412 are assigned to the knockout 414. For example, dynamic lookback 412 can set a window of time between a first time (t−2) and a second time (t). Event 3, Event 2, and Event 1 are within dynamic lookback 412, and therefore can be considered for dynamic label attribution 602. Event n, however, occurs at time (t−n), prior to the dynamic lookback 412, and therefore is assigned to knockout 414.

After applying the dynamic lookback 412, dynamic label attribution 602 can be applied to the surviving events. Dynamic label attribution 602 refers to the process of selecting events and assigning labels to the events within a notification engagement pattern 410 that have survived the dynamic lookback period. Dynamic label attribution 602 involves evaluating one or more prior events based on their relevance to the final disinterest action 408 and assigning appropriate labels (e.g., positive, negative, or neutral) to those events that reflect a user's engagement or disinterest with prior notifications. The dynamic label attribution 602 thereby ensures that the labeled training data 308 accurately represents user behavior leading up to the disinterest action 408. For example, consider a notification engagement pattern 410 where a user receives multiple notifications of a same type (e.g., connection recommendations, event notices, etc.) over a 14-day period, ignores most of them, and eventually disables the notification type. In this case, dynamic label attribution 602 would assign positive labels to the ignored notifications within the lookback period, as they are indicative of the user's growing disinterest in this notification type. Conversely, if the user clicked on a notification but later disabled the notification type, the click action might be assigned a negative label, as it does not align with the disinterest behavior. Another example involves a user who dismisses several push notifications over a week and then uninstalls the underlying application. Dynamic label attribution 602 might label the dismissed notifications as positive indicators of disinterest, while any interactions outside the lookback period or non-dismissal interactions within the lookback period would be excluded. This approach ensures that the notification engagement pattern 410 for a respective disinterest action 408 includes the most relevant events which ultimately ended with the disinterest action 408.

FIG. 6 further illustrates an example application of the dynamic label attribution 602. As shown, dynamic label attribution 602 results in assigning a positive label 604 to Event 3, while Event 2 is assigned to the knockout 414. This might occur, for example, if Events 1 and 3 are notification deletion actions while Event 2 is an application deletion action. Notably, a “positive label” in this context means that the corresponding event was associated with a notification disinterest action (meaning, for example, a negative user experience/interaction with the notification). The final result, the resulting notification engagement pattern 410 for a disinterest action 408 (e.g., Event 1), therefore includes the sequence [Event 3, Event 1]. Notably, the resulting notification engagement pattern 410 for a disinterest action 408 (e.g., Event 1) can include, in addition to the final event itself, one or more prior events, thereby resulting in a larger, richer dataset (the labeled training data 308). The labeled training data 308 can then be used to train the disinterest model 134 (refer to FIG. 1), thereby enhancing the ability of the disinterest model 134 to predict future disinterest towards candidate notifications.

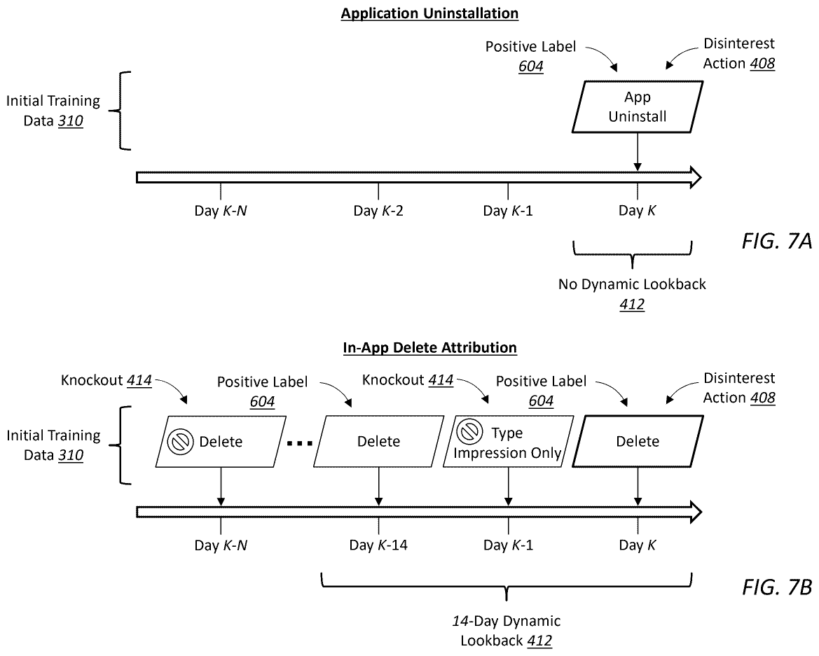

Illustrative examples for the dynamic lookback and labeling procedure 600 of FIG. 6 are discussed with respect to FIGS. 7A-9.

FIG. 7A depicts a block diagram of an example training data labeling phase for an application uninstallation in accordance with one or more embodiments. As shown in FIG. 7A, the disinterest action 408 is the deletion of an application. In this case, the event (here, an application uninstall action) is assigned a positive label 604. For some disinterest classes, such as application uninstallations, the dynamic lookback 412 is set to zero (that is, there is no dynamic lookback). Allowing zero-duration dynamic lookbacks ensures that the resulting notification engagement pattern 410 does not include any prior actions towards notifications as positive labels 604. This can be helpful in contexts such as application installations because uninstalling an application can result from factors outside of notification engagement, such as a notification recipient changing their phone, speeding up their phone, finishing their job search, etc. Thus, for application uninstall actions, the notification engagement pattern 410 only includes the disinterest action 408 itself.

FIG. 7B depicts a block diagram of an example training data labeling phase for an in-application deletion attribution in accordance with one or more embodiments. In some embodiments, notification engagement patterns 410 for in-application deletions are built by only considering prior notification deletion instances as positive labels 604. In this scenario, notification recipient and deleted notification pairs can be denoted by positive labels 604 having 2-tuple values: (m, n). In some embodiments, negative labels are not considered for in-application deletions, as those actions are considered less severe than notification disables and application deletions.

As shown in FIG. 7B, the disinterest action 408 is the deletion of a notification on day K, which is assigned a positive label 604. A 14-day dynamic lookback 412 and dynamic label attribution 602 are then applied as previously described to a variety of events occurring between days K−N to day K (K and N can themselves be arbitrarily defined as desired). As further shown in FIG. 7B, a deletion action on day K−N is assigned to knockout 414 as a result of the 14-day dynamic lookback 412. Conversely, a deletion action on day K−14 is assigned a positive label 604 and a type impression only action on day K−1 is assigned to knockout 414 as a result of dynamic label attribution 602.

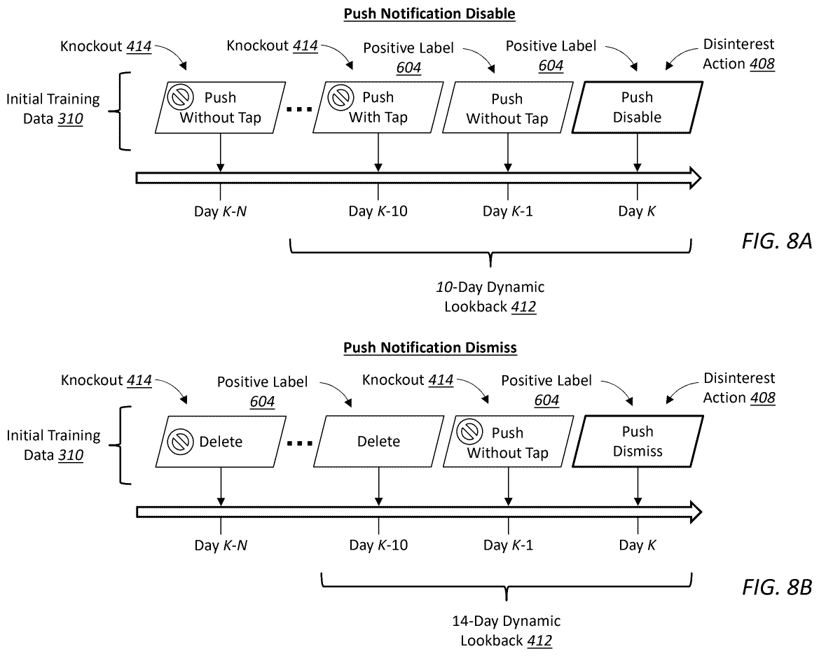

FIG. 8A depicts a block diagram of an example training data labeling phase for a push notification disable in accordance with one or more embodiments. In some embodiments, notification engagement patterns 410 for notification push disables are built by considering prior non-engagement behavior (such as viewing but not clicking on a push notification), as positive labels 604, in addition to the disable action itself. Conversely, notifications which resulted in engagement can be assigned negative labels.

As shown in FIG. 8A, the disinterest action 408 is a notification push disable on day K, which is assigned a positive label 604. A 10-day dynamic lookback 412 and dynamic label attribution 602 are then applied as previously described to a variety of events occurring between days K−N to day K. As further shown in FIG. 8A, a push without tap (that is, a push without engagement) action on day K−N is assigned to knockout 414 as a result of the 10-day dynamic lookback 412. Conversely, a push without tap action on day K−1 is assigned a positive label 604 and a push with tap (a push with engagement) on day K−10 is assigned to knockout 414 as a result of dynamic label attribution 602. Alternatively, the push with tap action on day K−10 can be assigned a negative label.

FIG. 8B depicts a block diagram of an example training data labeling phase for a push notification dismiss in accordance with one or more embodiments. In some embodiments, notification engagement patterns 410 for notification push dismiss are built by considering prior stand-alone actions, such as notification deletions and application uninstallations, as positive labels 604.

As shown in FIG. 8B, the disinterest action 408 is a notification push dismiss on day K, which is assigned a positive label 604. A 14-day dynamic lookback 412 and dynamic label attribution 602 are then applied as previously described to a variety of events occurring between days K−N to day K. As further shown in FIG. 8B, a deletion action on day K−N is assigned to knockout 414 as a result of the 14-day dynamic lookback 412. Conversely, a deletion action on day K−10 is assigned a positive label 604 and a push without tap on day K−1 is assigned to knockout 414 as a result of dynamic label attribution 602.

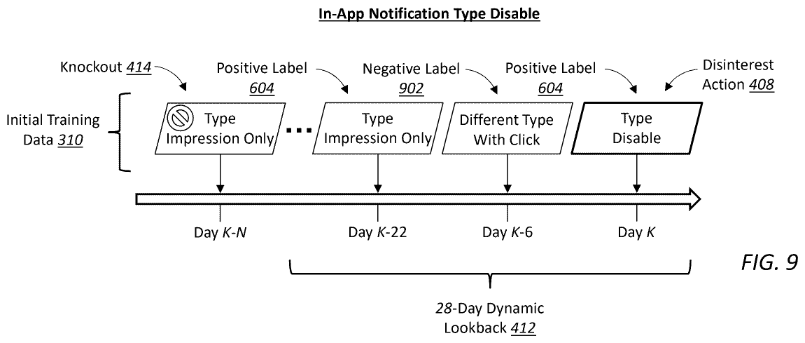

FIG. 9 depicts a block diagram of an example training data labeling phase for an in-application notification type disable in accordance with one or more embodiments. In some embodiments, notification engagement patterns 410 for notification type disables are built by considering, for notifications of the same notification type, prior notification impressions without engagement (e.g., notifications without clicks) as disinterest actions assigned positive labels 604. Negative labels, corresponding to notification interest, can be collected for the same member by searching prior notification actions within the dynamic lookback 412 for notifications of different types with engagements (e.g., clicks, dwells for longer than some predetermined threshold, etc.).

As shown in FIG. 8B, the disinterest action 408 is a notification type disable on day K, which is assigned a positive label 604. A 28-day dynamic lookback 412 and dynamic label attribution 602 are then applied as previously described to a variety of events occurring between days K−N to day K. As further shown in FIG. 9, a notification of the same type, without engagement (a “type impression only”) action on day K−N is assigned to knockout 414 as a result of the 28-day dynamic lookback 412. Conversely, a type impression only action on day K−22 is assigned a positive label 604 and a notification of a different type with engagement (a “different type with click”) action on day K−6 is assigned to negative label 902 as a result of dynamic label attribution 602.

Similar procedures can be carried out for other disinterest action types, and those specifically shown in FIGS. 7A-9 are merely illustrative of the variety of techniques possible when building notification engagement patterns 410. For example, if a member unfollows an author after receiving a notification related to that author, a notification engagement patterns 410 can be built by finding all other authors within the dynamic lookback 412 that the member also unfollowed. In another example, if a member disables all badge updates on the operating system level (perhaps disabling all push notifications), a notification engagement patterns 410 can be built that solely considers the last (more recent) notification impressed to that member.

Turning now to FIG. 10, in some embodiments, one or more of the models (e.g., disinterest model 134, model 120, model 128, etc.) previously described can be implemented in whole or in part as a multilayer perceptron (MLP) 1000, which is a type of feedforward artificial neural network that consists of multiple layers of interconnected nodes 1002. In this implementation, the MLP 1000 includes one or more fully connected layers 1004 using recipient, actor, and item features (e.g., actor features 114, recipient features 110, etc.) as input (collectively defining an input layer 1006). In this type of implementation, the output layer 1008 can include a notification disinterest prediction (e.g., disinterest 130), a recipient-actor tower embedding (e.g., actor embedding 116), an item-actor tower embedding (e.g., item embedding 124), etc., depending on the underlying system being implemented. The depth, width, dimensionality, etc., of the MLP 1000 need not be particularly limited, and the construction shown in FIG. 10 is merely illustrative.

In some embodiments, MLP 1000 includes one or more nodes 1002 (neurons) arranged in each of the fully connected layers 1004. Nodes 1002 in adjacent fully connected layers 1004 are connected by weighted edges 1010, where the weight of a respective edge represents the strength of the connection between the respective nodes 1002. These weights are adjusted during the learning process. In some embodiments, each node 1002 in the MLP 1000 performs a weighted sum of its inputs, adds a bias term, and then, optionally, applies a non-linear activation function to produce an output. The nonlinear activation function, such as a rectified linear unit (ReLU), sigmoid, or tanh function, can be applied to the outputs of each node 1002 to introduce nonlinearity, allowing the MLP 1000 to learn more complex notification disinterest patterns.

Turning now to FIG. 11, in some embodiments, one or more of the models (e.g., disinterest model 134, model 120, etc.) previously described can be implemented in whole or in part using a transformer 1100, such as those relied upon in some large language models (LLMs). In some embodiments, transformer 1100 includes an encoder 1106 trained to generate embeddings (e.g., recipient embeddings 112, actor embedding 116, etc.). While not meant to be particularly limited, the transformer 1100 and/or encoder 1106 can include a neural network machine learning architecture that is capable of processing large amounts of text data and generating high-quality natural language responses. In practice, large language models have been used for a wide range of natural language processing (NLP) tasks, including, for example, machine translation, text generation, sentiment analysis, and question answering (i.e., query-and-response). Large language models have also been adapted for other domains, such as computer vision, speech recognition, and software development.

At its core, a large language model consists of an encoder and a decoder. The encoder takes in a sequence of input tokens, such as words or characters, and produces a sequence of hidden representations for each token that capture the contextual information of the input sequence. The decoder then uses these hidden representations, along with a sequence of target tokens, to generate a sequence of output tokens.

The most popular and widely used types of large language models are recurrent neural networks (RNNs) and transformers. RNNs are neural networks that process sequences of inputs one by one, and use a hidden state to remember previous inputs. RNNs are particularly well-suited for tasks that involve sequential data, such as text, audio, and time-series data. In a transformer, on the other hand, the encoder and decoder are composed of multiple layers of multi-headed self-attention and feedforward neural networks. The core of the transformer model is the self-attention mechanism, which allows the model to focus on different parts of an input sequence at different timesteps, without the need for recurrent connections that process the sequence one by one. Transformers leverage self-attention to compute representations of input sequences in a parallel and context-aware manner and are well-suited to tasks that require capturing long-range dependencies between words in a sentence, such as in language modeling and machine translation.

Large language models are typically trained on large amounts of text data, often containing hundreds of millions if not billions of words. To handle the large amount of data, the training process is often highly parallelized. The training process can take several days or even weeks, depending on the size of the model and the amount of training data involved. Large language models can be trained using backpropagation and gradient descent, with the objective of minimizing a loss function such as cross-entropy loss.

As shown in FIG. 11, the transformer 1100 begins with an input 1102. The input 1102 denotes an input provided by a user (or upstream system) and can be represented as a sequence of tokens, individual words or sub-words, from which input embeddings 1104 can be generated. The input embeddings 1104 represent the tokens within the input 1102 as numbers, which can be processed using encoder 1106. In some embodiments, a positional encoding 1108 can be generated to encode the position of each token in input 1102 as a set of numbers. These numbers can be fed into the encoder 1106 with the input embeddings 1104, allowing the transformer-based architecture to more effectively understand the order of words in a sentence and to thereby generate grammatically correct and semantically meaningful outputs.

The encoder 1106 processes the input embeddings 1104 and the positional encoding 1108 and generates, for the input 1102, an encoded representation 1110 (in various implementations, the actor embedding 116, recipient embedding 112, item embedding 124, etc.) that captures the meaning and context of the input 1102. To accomplish this, encoder 1106 applies a series of self-attention transformer layers (or simply, “transformer layers”), which are a series of hidden states that represent the input 1102 at different levels of abstraction. The encoder 1106 can include any number of these transformer layers, as desired. In some embodiments, the encoded representation 1110 is provided to a decoder 1112.

The decoder 1112 similarly includes a number of transformer layers, as desired, except that the decoder 1112 processes an output 1114. In most implementations, the output 1114 is a right-shifted copy of the input 1102, meaning that the decoder 1112 can only use the previous words for next-token prediction. In some embodiments, output embeddings 1116 can be generated from the output 1114 to represent the tokens in the output 1114 as numbers, in a similar manner as described with respect to the encoder 1106. A positional encoding 1118 can be added to the output embeddings 1116 to encode the position of each token in output 1114 as a set of numbers. The decoder 1112 can be trained by minimizing a loss function (also known as an objective function, which quantifies a difference between a predicted output and a known true value) using, for example, gradient descent. Once trained, the transformer 1100 can be used during an inference phase to generate an output 1120, which can be thought of as a next-token probability (that is, how likely is the next token in the sequence to be x, or y, etc.). In some configurations, the transformer-based architecture includes a linear layer and SoftMax layer (omitted for clarity) to transform a raw output from the decoder 1112 into the output 1114. For example, after the decoder 1112 produces a raw output (e.g., output embeddings), the linear layer can map the output embeddings to a higher-dimensional space, thereby transforming the output embeddings into a same original input space as the input 1102. The SoftMax function can be used to generate a probability distribution for each output token in the vocabulary, enabling the transformer-based meta block 106 to generate output tokens with probabilities (e.g., the output 1120).

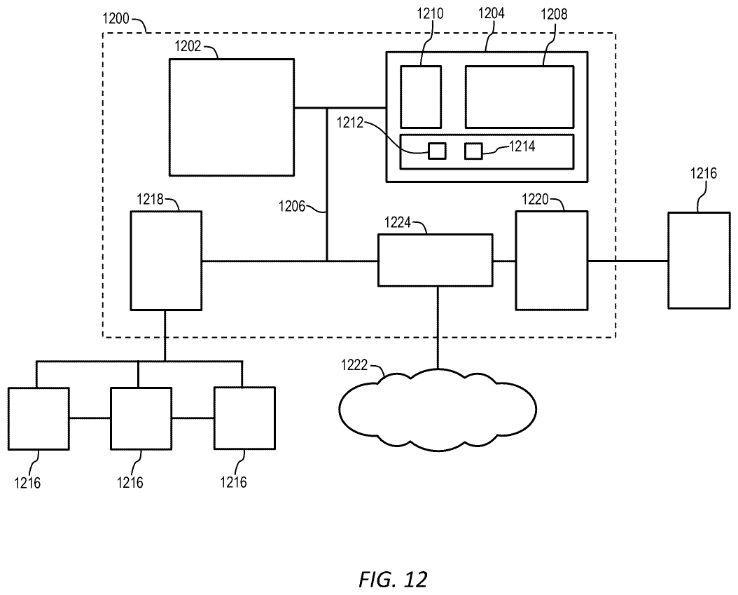

FIG. 12 illustrates aspects of an embodiment of a computer system 1200 that can perform various aspects of embodiments described herein. In some embodiments, the computer system(s) 1200 can implement and/or otherwise be incorporated within or in combination with any component, module, or model of the notification disinterest prediction system 100 (refer to FIGS. 1-11). In some embodiments, a computer system 1200 can be implemented server-side. For example, a remote computer system 1200 can be configured to receive a candidate notification and to generate, in response, a disinterest prediction.

The computer system 1200 includes at least one processing device 1202, which generally includes one or more processors or processing units for performing a variety of functions, such as, for example, completing any portion of the hybrid meta learning recommendation service 100 described previously. Components of the computer system 1200 also include a system memory 1204, and a bus 1206 that couples various system components including the system memory 1204 to the processing device 1202. The system memory 1204 may include a variety of computer system readable media. Such media can be any available media that is accessible by the processing device 1202, and includes both volatile and non-volatile media, and removable and non-removable media. For example, the system memory 1204 includes a non-volatile memory 1208 such as a hard drive, and may also include a volatile memory 1210, such as random access memory (RAM) and/or cache memory. The computer system 1200 can further include other removable/non-removable, volatile/non-volatile computer system storage media.

The system memory 1204 can include at least one program product having a set (e.g., at least one) of program modules that are configured to carry out functions of the embodiments described herein. For example, the system memory 1204 stores various program modules that generally carry out the functions and/or methodologies of embodiments described herein. A module or modules 1212, 1214 may be included to perform functions related to any of the block diagrams described herein. The computer system 1200 is not so limited, as other modules may be included depending on the desired functionality of the computer system 1200. As used herein, the term “module” refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The processing device 1202 can also be configured to communicate with one or more external devices 1216 such as, for example, a keyboard, a pointing device, and/or any devices (e.g., a network card, a modem, etc.) that enable the processing device 1202 to communicate with one or more other computing devices. Communication with various devices can occur via Input/Output (I/O) interfaces 1218 and 1220.

The processing device 1202 may also communicate with one or more networks 1222 such as a local area network (LAN), a general wide area network (WAN), a bus network and/or a public network (e.g., the Internet) via a network adapter 1224. In some embodiments, the network adapter 1224 is or includes an optical network adaptor for communication over an optical network. It should be understood that although not shown, other hardware and/or software components may be used in conjunction with the computer system 1200. Examples include, but are not limited to, microcode, device drivers, redundant processing units, external disk drive arrays, RAID systems, and data archival storage systems, etc.

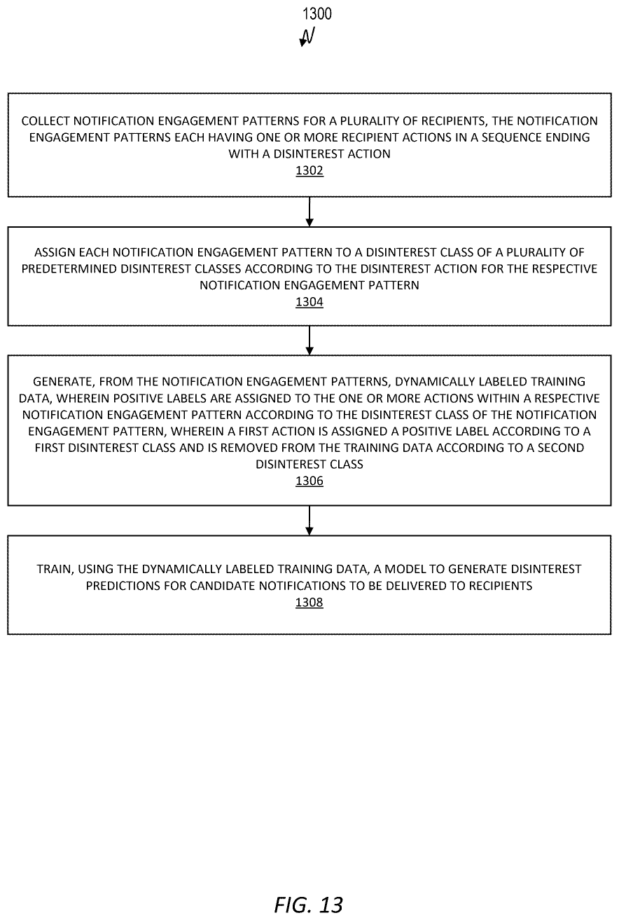

Referring now to FIG. 13, a flowchart 1300 for predicting notification disinterest is generally shown according to an embodiment. The flowchart 1300 is described with reference to FIGS. 1 to 12 and may include additional steps not depicted in FIG. 13. Although depicted in a particular order, the blocks depicted in FIG. 13 can be, in some embodiments, rearranged, subdivided, and/or combined.

At block 1302, the method includes collecting notification engagement patterns for a plurality of recipients. In some embodiments, the notification engagement patterns each include one or more actions in a sequence ending with a disinterest action.

At block 1304, the method includes assigning each notification engagement pattern to a disinterest class of a plurality of predetermined disinterest classes according to the disinterest action for the respective notification engagement pattern.

At block 1306, the method includes generating, from the notification engagement patterns, dynamically labeled training data. In some embodiments, positive labels are assigned to actions within a respective notification engagement pattern according to the disinterest class of the notification engagement pattern. In some embodiments, a first action can be assigned a positive label according to a first disinterest class but can be assigned a different label, or removed from the training data, according to a second disinterest class.

At block 1308, the method includes training, using the dynamically labeled training data, a model (e.g., disinterest model 134) to generate disinterest predictions (e.g., disinterest 130) for candidate notifications to be delivered to recipients.

In some embodiments, the method includes, during an inference phase, receiving a candidate notification, generating an output from the model comprising a disinterest prediction for the candidate notification, and filtering the candidate notification according to the disinterest prediction.

In some embodiments, the method includes, during the inference phase, generating, by a recipient-actor tower, a first embedding encoding actor and recipient-actor features associated with the candidate notification (refer to recipient-actor tower 104). In some embodiments, the method includes, during the inference phase, generating, by a recipient encoder, a second embedding encoding recipient features associated with the candidate notification (refer to recipient encoder 102). In some embodiments, the method includes, during the inference phase, generating, by a recipient-item tower, a third embedding encoding item and recipient-item features associated with the candidate notification (refer to recipient-item tower 106). In some embodiments, the method includes, during the inference phase, passing, to the model (e.g., the disinterest tower 108, refer to FIG. 1), the first embedding, the second embedding, and the third embedding.

In some embodiments, generating the dynamically labeled training data for a respective notification engagement pattern includes filtering the one or more actions in the respective sequence ending with the respective disinterest action of the notification engagement pattern according to a variable lookback period. As used herein, a “variable” lookback period refers to a lookback period which varies in length (e.g., 4 hours, 2 days, 14 days, etc.) as a function of the class of the underlying notification engagement pattern. In other words, each class can correspond to a different lookback period.

In some embodiments, the variable lookback period can be set based on the severity of the disinterest action associated with each disinterest classification type. For example, a less severe disinterest action, such as ignoring a notification, might have a shorter lookback period, while a more severe action, such as uninstalling the application, might have a longer lookback period. This approach allows the system to capture additional event data for relatively more severe disinterest actions.

Alternatively, or in addition, the variable lookback period can be set based on the nature of the disinterest action associated. This approach allows the system to focus on only the most relevant event data for a particular disinterest action. For instance, for a notification ignore class where a user has ignored a notification, a relatively shorter lookback period of 2 to 4 days might be set to capture only the most relatively recent interactions that might have led to the user's decision to ignore the notification. On the other hand, for an application uninstallation class where a user uninstalls the application associated with the notification, the longest lookback period might be set to 0 (no lookback at all). This can be helpful in contexts such as application uninstallations because uninstalling an application can result from factors outside of notification engagement, such as a notification recipient changing their phone, speeding up their phone, finishing their job search, etc. Thus, setting the lookback to zero can avoid corrupting the training data with events which were not actually relevant to the disinterest action. In another example, for a notification dismiss class where users actively dismiss notifications, a moderate lookback period of 7 to 10 days might be set to allow the system to capture a broader range of interactions, including any patterns of dismissal that indicate growing disinterest. In yet another example, for a notification type disable class where users disable a specific type of notification, a relatively longer lookback period of 14 to 28 days might be set to capture the cumulative effect of multiple notifications of the same type over time, providing a comprehensive view of the user's evolving notification behavior towards that notification type. In still another example, for a global notification disable class where users disable all notifications from the application, an extended lookback period of 30 to 60 days, or even longer, might be set to broadly capture a user's overall experience with notifications.

By setting variable lookback periods for each disinterest classification type, the system can ensure that the training data includes the most relevant events leading up to each respective disinterest action. This approach enhances the model's ability to learn from user behavior and to accurately predict future disinterest actions, ultimately improving the effectiveness of the notification disinterest prediction system.

In some embodiments, the system can learn the dynamic lookback window for each class. For example, in some embodiments, the system can learn the dynamic lookback window for each class by employing machine learning techniques that optimize the lookback period based on historical data and user behavior patterns. This process involves analyzing sequences of user interactions leading up to disinterest actions and determining the most relevant time frames that would have contributed to an accurate prediction of the known behavior. The system can use various methods to learn and adjust the dynamic lookback window for each disinterest class. One approach can include the use of data-driven analysis. For example, the system can analyze historical engagement data to identify the time frames within which user interactions are most predictive of disinterest actions. By examining the distribution of engagement patterns and the timing of disinterest actions, the system can determine the optimal lookback period for each class. For example, if a majority of disinterest actions for a specific class occur within a 14-day window, the system may set the lookback period to 14 days for that class. Another approach might include cross-validation, where the system partitions training data into training and validation sets and tests, for each class, various lookback periods and then measures their impact on the model's predictive accuracy. The lookback period that results in the highest validation performance can be selected as the optimal window for each class. Hyperparameter optimization offers yet another approach. During this process the system can treat the lookback period as a hyperparameter and can use optimization algorithms, such as grid search or random search, to find the best value for each class. These algorithms systematically explore different lookback periods and evaluate their impact on the model's performance, ultimately selecting the period that yields the most accurate predictions. Sequential model training can also be used. These techniques involve training one or more sequential models, such as recurrent neural networks (RNNs) or long short-term memory (LSTM) networks, that inherently capture temporal dependencies in the data. These models can learn the optimal lookback period by adjusting their internal states based on the timing and sequence of user interactions, effectively identifying the most relevant time frames for each disinterest class. In yet another example, the system might use feature importance analysis to determine the significance of different time windows in predicting disinterest actions. By evaluating the contribution of features representing different lookback periods, the system can identify which time frames are most predictive and adjust the lookback window accordingly. Of course, these approaches are merely illustrative. Moreover, the system can use any combination of these approaches, and all such configurations are within the contemplated scope of this disclosure.

In some embodiments, the variable lookback period is dynamically set according to the predetermined and/or learned disinterest class of the respective notification engagement pattern.

In some embodiments, the variable lookback period includes a first interval for the first disinterest class and a second interval for the second disinterest class.

In some embodiments, the disinterest action includes an application uninstallation action, an in-application deletion action, a push notification disable action, a push notification dismiss action, and/or an in-application notification type disable action.

In some embodiments, the disinterest actions is sparce data representing less than 10, 5, 3, 2, 1, 0.5 percent of the available training data. In some embodiments, the disinterest actions is sparce data representing less than three percent of the available training data. In some embodiments, the disinterest actions is sparce data representing less than one percent of the available training data. In some embodiments, the disinterest actions is sparce data representing less than half a percent of the available training data.

The techniques described herein may be implemented with privacy safeguards to protect user privacy. Furthermore, the techniques described herein may be implemented with user privacy safeguards to prevent unauthorized access to personal data and confidential data. The training of the AI models described herein is executed to benefit all users fairly, without causing or amplifying unfair bias.

According to some embodiments, the techniques for the models described herein do not make inferences or predictions about individuals unless requested to do so through an input. According to some embodiments, the models described herein do not learn from and are not trained on user data without user authorization. In instances where user data is permitted and authorized for use in AI features and tools, it is done in compliance with a user's visibility settings, privacy choices, user agreement and descriptions, and the applicable law. According to the techniques described herein, users may have full control over the visibility of their content and who sees their content, as is controlled via the visibility settings. According to the techniques described herein, users may have full control over the level of their personal data that is shared and distributed between different AI platforms that provide different functionalities. According to the techniques described herein, users may choose to share personal data with different platforms to provide services that are more tailored to the users. In instances where the users choose not to share personal data with the platforms, the choices made by the users will not have any impact on their ability to use the services that they had access to prior to making their choice. According to the techniques described herein, users may have full control over the level of access to their personal data that is shared with other parties. According to the techniques described herein, personal data provided by users may be processed to determine prompts when using a generative AI feature at the request of the user, but not to train generative AI models. In some embodiments, users may provide feedback while using the techniques described herein, which may be used to improve or modify the platform and products. In some embodiments, any personal data associated with a user, such as personal information provided by the user to the platform, may be deleted from storage upon user request. In some embodiments, personal information associated with a user may be permanently deleted from storage when a user deletes their account from the platform.

According to the techniques described herein, personal data may be removed from any training dataset that is used to train AI models. The techniques described herein may utilize tools for anonymizing member and customer data. For example, user's personal data may be redacted and minimized in training datasets for training AI models through delexicalization tools and other privacy enhancing tools for safeguarding user data. The techniques described herein may minimize use of any personal data in training AI models, including removing and replacing personal data. According to the techniques described herein, notices may be communicated to users to inform how their data is being used and users are provided controls to opt-out from their data being used for training AI models.

According to some embodiments, tools are used with the techniques described herein to identify and mitigate risks associated with AI in all products and AI systems. In some embodiments, notices may be provided to users when AI tools are being used to provide features.

While the disclosure has been described with reference to various embodiments, it will be understood by those skilled in the art that changes may be made and equivalents may be substituted for elements thereof without departing from its scope. The various tasks and process steps described herein can be incorporated into a more comprehensive procedure or process having additional steps or functionality not described in detail herein. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

Unless defined otherwise, technical and scientific terms used herein have the same meaning as is commonly understood by one of skill in the art to which this disclosure belongs.

Various embodiments of the present disclosure are described herein with reference to the related drawings. The drawings depicted herein are illustrative. There can be many variations to the diagrams and/or the steps (or operations) described therein without departing from the spirit of the disclosure. For instance, the actions can be performed in a differing order or actions can be added, deleted or modified. All of these variations are considered a part of the present disclosure.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof. The term “or” means “and/or” unless clearly indicated otherwise by context.

The terms “received from”, “receiving from”, “passed to”, “passing to”, etc. describe a communication path between two elements and does not imply a direct connection between the elements with no intervening elements/connections therebetween unless specified. A respective communication path can be a direct or indirect communication path.

The corresponding structures, materials, acts, and equivalents of all means or step plus function elements in the claims below are intended to include any structure, material, or act for performing the function in combination with other claimed elements as specifically claimed.

For the sake of brevity, conventional techniques related to making and using aspects of the present disclosure may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Embodiments of the present disclosure may be implemented as or as part of a system, a method, and/or a computer program product at any possible technical detail level of integration. The computer program product may include a computer readable storage medium (or media) having computer readable program instructions thereon for causing a processor to carry out aspects of the present disclosure.

Various embodiments are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a special purpose computer to produce a machine, such that the instructions, which execute via the processor of the special purpose computer, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments described herein have been presented for purposes of illustration, but are not intended to be exhaustive or limited to the form(s) disclosed. The embodiments were chosen and described in order to best explain the principles of the disclosure. Many modifications and variations will be apparent to those of ordinary skill in the art without departing from the scope and spirit of the described embodiments. The terminology used herein was chosen to best explain the principles of the various embodiments, the practical application or technical improvement over technologies found in the marketplace, or to enable others of ordinary skill in the art to understand the embodiments described herein.

What is claimed is:

1. A method comprising:
collecting notification engagement patterns for a plurality of recipients, the notification engagement patterns comprising one or more recipient actions in a sequence ending with a disinterest action;
assigning each notification engagement pattern to a disinterest class of a plurality of predetermined disinterest classes according to the disinterest action for the respective notification engagement pattern;
generating, from the notification engagement patterns, dynamically labeled training data, wherein positive labels are assigned to the one or more recipient actions within a respective notification engagement pattern according to the disinterest class of the notification engagement pattern, wherein a first action is assigned a positive label according to a first disinterest class and is removed from the training data according to a second disinterest class; and
training, using the dynamically labeled training data, a model to generate disinterest predictions for candidate notifications to be delivered to recipients.

2. The method of claim 1, further comprising, during an inference phase:
receiving a candidate notification;
generating an output from the model comprising a disinterest prediction for the candidate notification; and
filtering the candidate notification according to the disinterest prediction.

3. The method of claim 2, further comprising, during the inference phase:
generating, by a recipient-actor tower, a first embedding encoding actor and recipient-actor features associated with the candidate notification;
generating, by a recipient encoder, a second embedding encoding recipient features associated with the candidate notification;
generating, by a recipient-item tower, a third embedding encoding item and recipient-item features associated with the candidate notification; and
passing, to the model, the first embedding, the second embedding, and the third embedding.

4. The method of claim 1, wherein generating the dynamically labeled training data for a respective notification engagement pattern comprises filtering the one or more actions in the respective sequence ending with the respective disinterest action of the notification engagement pattern according to a variable lookback period.

5. The method of claim 4, wherein the variable lookback period is dynamically set according to the disinterest class of the respective notification engagement pattern.

6. The method of claim 5, wherein the variable lookback period comprises a first interval for the first disinterest class and a second interval for the second disinterest class.

7. The method of claim 1, wherein the disinterest actions comprise sparce data representing less than one percent of the available training data.

8. A system comprising a memory, computer readable instructions, and one or more circuitry for executing the computer readable instructions, the computer readable instructions controlling the one or more circuitry to perform operations comprising:
collect notification engagement patterns for a plurality of recipients, the notification engagement patterns comprising one or more recipient actions in a sequence ending with a disinterest action;
assign each notification engagement pattern to a disinterest class of a plurality of predetermined disinterest classes according to the disinterest action for the respective notification engagement pattern;
generate, from the notification engagement patterns, dynamically labeled training data, wherein positive labels are assigned to the one or more recipient actions within a respective notification engagement pattern according to the disinterest class of the notification engagement pattern, wherein a first action is assigned a positive label according to a first disinterest class and is removed from the training data according to a second disinterest class; and
train, using the dynamically labeled training data, a model to generate disinterest predictions for candidate notifications to be delivered to recipients.

9. The system of claim 8, wherein, during an inference phase, the operations further comprise:
receive a candidate notification;
generate an output from the model comprising a disinterest prediction for the candidate notification; and
filter the candidate notification according to the disinterest prediction.

10. The system of claim 9, wherein, during the inference phase, the operations further comprise:
generate, by a recipient-actor tower, a first embedding encoding actor and recipient-actor features associated with the candidate notification;
generate, by a recipient encoder, a second embedding encoding recipient features associated with the candidate notification;
generate, by a recipient-item tower, a third embedding encoding item and recipient-item features associated with the candidate notification; and
pass, to the model, the first embedding, the second embedding, and the third embedding.

11. The system of claim 8, wherein generating the dynamically labeled training data for a respective notification engagement pattern comprises filtering the one or more actions in the respective sequence ending with the respective disinterest action of the notification engagement pattern according to a variable lookback period.

12. The system of claim 11, wherein the variable lookback period is dynamically set according to the disinterest class of the respective notification engagement pattern.

13. The system of claim 12, wherein the variable lookback period comprises a first interval for the first disinterest class and a second interval for the second disinterest class.

14. The system of claim 8, wherein the disinterest actions comprise sparce data representing less than one percent of the available training data.

15. A computer program product comprising a computer readable storage medium having program instructions embodied therewith, the program instructions executable by one or more circuitry to cause the one or more circuitry to perform operations comprising:
collect notification engagement patterns for a plurality of recipients, the notification engagement patterns comprising one or more recipient actions in a sequence ending with a disinterest action;
assign each notification engagement pattern to a disinterest class of a plurality of predetermined disinterest classes according to the disinterest action for the respective notification engagement pattern;
generate, from the notification engagement patterns, dynamically labeled training data, wherein positive labels are assigned to the one or more recipient actions within a respective notification engagement pattern according to the disinterest class of the notification engagement pattern, wherein a first action is assigned a positive label according to a first disinterest class and is removed from the training data according to a second disinterest class; and
train, using the dynamically labeled training data, a model to generate disinterest predictions for candidate notifications to be delivered to recipients.

16. The computer program product of claim 15, wherein, during an inference phase, the operations further comprise:
receive a candidate notification;
generate an output from the model comprising a disinterest prediction for the candidate notification; and
filter the candidate notification according to the disinterest prediction.

17. The computer program product of claim 16, wherein, during the inference phase, the operations further comprise:
generate, by a recipient-actor tower, a first embedding encoding actor and recipient-actor features associated with the candidate notification;
generate, by a recipient encoder, a second embedding encoding recipient features associated with the candidate notification;
generate, by a recipient-item tower, a third embedding encoding item and recipient-item features associated with the candidate notification; and
pass, to the model, the first embedding, the second embedding, and the third embedding.

18. The computer program product of claim 15, wherein generating the dynamically labeled training data for a respective notification engagement pattern comprises filtering the one or more actions in the respective sequence ending with the respective disinterest action of the notification engagement pattern according to a variable lookback period.

19. The computer program product of claim 18, wherein the variable lookback period is dynamically set according to the disinterest class of the respective notification engagement pattern.

20. The computer program product of claim 19, wherein the variable lookback period comprises a first interval for the first disinterest class and a second interval for the second disinterest class.
